(19) United States
(12) Patent Application Publication
(10) Pub. No.: US 2009/0100094 A1
(43) Pub. Date: Apr. 16, 2009

(54) Recommendation system and method for multimedia content

(76) Inventors: Xavier Verdaguer, Barcelona (ES); Luigi Ceccaroni, Barcelona (ES); Jordi Casas, Barcelona (ES); Victor Codina, Girona (ES)

Correspondence Address: COLLARD & ROE, P.C., 1077 NORTHERN BOULEVARD, ROSLYN, NY, 11576, US

(21) Appl. No.: 11/974,561

(22) Filed: Oct. 15, 2007

(51) Int. Cl. G06F 17/30

(52) U.S. Cl. 707/104.1; 707/E17.009

(57) ABSTRACT

A recommendation method for multimedia content and a computer program for performing the method includes in one aspect the steps of obtaining at least two lists of recommended titles, each list being obtained according to a different approach, base on a user database and a content database, combining the at least two lists of recommended titles so obtained based on confidence levels in order to obtain a final list of recommended titles, and recommending the final list of recommended titles to a user.

### FIELD OF THE INVENTION

The present invention relates to a recommendation system and method for providing a recommendation of multimedia content to a user. Particularly, the object of the present invention is choosing from a multimedia content database a list of titles the user is most likely to enjoy. Another object of the present invention is obtaining a list of users for recommending a new title arriving at the database.

### BACKGROUND OF THE INVENTION

In an era of increased availability of multimedia content, recommendation technologies are a necessary tool to help people select what they consume. Nowadays, when a user wishes to watch a movie, he may have to choose from a database formed of hundreds or thousands of titles, as is the case of, for example, subscription TV channels, hotel video services or internet databases. These technologies help people manage multimedia content overload and discover multimedia content they would never have found on their own. An additional advantage of the present invention is saving the users the time otherwise employed in tedious searches.

The challenge in the field of recommendation technologies is matching multimedia content to people's preferences. There are basically three approaches for this task.

Content-based recommendation consists of recommending multimedia content that matches preferences explicitly expressed by the user, usually by means of filling a questionnaire. The key element of this method is the similarity measure that indicates how related is some multimedia content to a certain user. The main disadvantage is that recommendations are usually very similar to each other (overspecialization). In addition, many times the user does not provide the system with enough information relating to his multimedia content preferences. On the other hand, the advantage with respect to other methods is that recommendations can be provided without using a record of previous user-behavior (user's history).

Case-based recommendation consists of recommending multimedia content similar to what the user has consumed and positively evaluated in the past (Montaner, M, “Collaborative Recommender Agents Based on Case-based Reasoning and Trust”, PhD Thesis, 2003). Thus, in order to successfully use this method, the user must evaluate (vote) the titles he consumes. An evaluation could be, for example, a number ranging from 1 to 5 expressing how much the user liked the title he has just consumed. The key elements of this approach are the similarity measure among titles and the classification of the multimedia content in user's history according to the relevance of each title for a particular user. The main disadvantage is overspecialization and that the quality of the recommendations is strictly related to the amount of evaluations provided by the user. The advantage is that recommendations for a specific user do not depend on the amount of votes provided by other users, but only on his own participation in the system.

Finally, Bayesian recommendation uses data related to the preferences of a certain set of users (user database) for recommending multimedia content a target user, with a certain profile, might like. Typically, these so-called cooperative filtering methods do not use any information regarding the actual multimedia content (in the case of movies, e.g., words, author, description), but are rather based on usage or preference patterns of other users. They are built on the assumption that a good way to recommend interesting multimedia content to a user is to find other people who have similar interests, and then recommend said user titles that those similar people like. There are generally two types of cooperative filtering algorithms (Breese, J. S., Heckerman, D., and Kadie, C., “Empirical Analysis of Predictive Algorithms for Collaborative Filtering”, 1998):
Memory-based collaborative filtering: In operates directly over the entire user database to make recommendations. Statistical techniques are employed to find a set of users, known as neighbors, who have a history of agreeing with the target user.
Model-based collaborative filtering: The database is used to make a model, which is then used for making the recommendations. Plausible models for collaborative filtering are cluster models (Cheesman, P., Stutz, J., “Bayesian Classification (AUTOCLASS): Theory and Results. In Advances in Knowledge Discovery” AAAI Press, 1995)), Bayesian network models and rule-based (or item-based) models (Sarwar B. M., et al., “Item-based Collaborative Filtering Recommendation Algorithms”, 10^{th} International World Wide Web Conference, ACM Press, 2001, pp. 285-295).

The main deficiencies of cooperative recommendation are the necessity of a high number of users with a high participation, its use being thus limited to web-based applications, users with uncommon tastes are badly recommended and new titles are not recommended until they are evaluated by a specific minimum number of users.

On the other hand, the main advantage of cooperative recommendation is that it solves the overspecialization problem and the dependence on the votes provided by the target user, typical of content-based and case-based approaches.

Regardless of the type of preference data available, recommendation algorithms have to address the issue of missing data: typically, there is not a complete set of preferences across all titles and it cannot be assumed that items are missing at random. In most applications, users express preferences on multimedia content they have accessed, and are more likely to access and express preferences on multimedia content they like. Making different assumptions about the nature of missing data can affect the performance of recommendation algorithms (Breese, J. S., Heckerman, D., and Kadie, C., “Empirical Analysis of Predictive Algorithms for Collaborative Filtering”, 1998). In order to overcome the limitations of each type of recommendation, in many occasions hybrid systems are used. A classification of these systems according to the form in which they combine the different approaches can be found in Burke R., “Hybrid Recommender Systems with Case-based Components”, ECCBR 2004, 91-105. Examples of hybrid systems are:
Fab (Balabanovic M. and Shoham Y., “Combining Content-Based and Collaborative Recommendation”. In communications of the ACM, 1997): A recommendation system and method for the web is described which combines content-based recommendation and collaborative filtering. User profiles are maintained through multimedia content analysis and these profiles are directly compared to determine similar users for collaborative recommendation.
Racofi Music (Anderson M., Ball M., Boley H, Greene S., Howse N., Lemire D., McGrath S., “RACOFI: A Rule-Applying Collaborative Filtering System”, In Proc. IEEE/WIC COLA'03, Halifax, Canada, October 2003): A music recommendation system and method is described which combines content-based and collaborative filtering employing a rule-based tool named RACOLA.
Personal Program Guide (Ardissono L., Gena C., Torasso P., Bellifemine F., Chiarotto A., Difino A., Negro B., “Personalized Recommendation of TV Programs”, Lecture Notes in Artificial Intelligence n. 2829. AI+IA 2003: Advances in Artificial Intelligence, Pisa, Italy, pp. 474-486, © Springer Verla). A user-adaptive Electronic Program Guide is described which uses three specialized user modeling modules to obtain a personalized user model. Then, the recommendation module employs a content-based approach based on user's preferences.
Avatar (Blanco Fernández, Y., Pazos Arias J. J., Gil Solla A., Ramos Cabrer M., Barragáns Martinez B. and López Nores M., “A Multi-Agent Open Architecture for a TV Recommender System: A Case Study using a Bayesian Strategy”, In Proc. Of the IEEE Sixth International Symposium on Multimedia Software Engineering, 2004): A recommendation system and method for personalized TV contents is described which employs three components, one based on Bayesian techniques, another one based on semantic reasoning and the third one based on profiles matching. Their recommendations are mixed by the combiner module, which is a neural network.

In US 2006/0100963, a content-based recommendation system is described which consists of a recommender and method of providing a recommendation of content. The recommender described in this invention determines, upon reception of a new content item, if said content item correlates with the user preference profile. If there is such an associative correspondence, then the content item is recommended to the user. Otherwise, the recommender determines if there is a characteristic in common between the received content item and those of a second content item having a high user preference. In such case, the received content item is recommended to the user.

US 2004/0230499 describes combination of content-based and case-based system and method for providing recommendation of goods and services based on recorded purchasing history. This invention recommends goods and services based on a potential customer's selection of goods and/or services and a database of previous customer purchasing history.

US 2006/0195362 describes a collaborative filtering recommendation system which analyzes purchase histories and/or other types of behavioral data of users on an aggregated basis to detect and quantify associations between particular items represented in an electronic catalogue. The detected associations are stored in a mapping structure that maps items to related items, and is used to recommend items to users of the electronic catalogue.

### SUMMARY OF THE INVENTION

In view of all of the above, a need still exists in the art to develop a recommendation system that overcomes on the whole the drawbacks of the aforementioned approaches.

The modular hybrid recommendation system of the present invention, through the combination of components with different characteristics, provides recommendations with enhanced consistency and precision. Furthermore, the appropriate combination of different approaches may eliminate or minimize the disadvantages shown by each approach alone. In addition, the system is easily extendable and modifiable.

First of all, a list of useful terms for the correct understanding of the present description will be provided.

The term “system” as used herein comprises all parts of the recommendation system of the invention. Specifically, it comprises the confidence level database, the combination module and the various components. In addition, a content database and a user database must be available to the system.

The term “approach” makes reference to the different techniques or methods used for recommending multimedia content to the users. The present document mentions basically three approaches, namely content-based, case-based and Bayesian, although other approaches are possible. The physical module or device in which the calculations for each of the approaches are made is called “component”. Thus, each approach is carried out in a specific component.

In the present description, the term “multimedia content” aims to make reference generally to any type of video item users may be interested in, usually related to leisure and entertainment. Examples of these, without limitation, would be films, movies, videos, music videos or TV series. When referring to a single piece of multimedia content, such as a specific movie, the term “title” will be used.

In order to recommend multimedia content to users, the present invention requires the multimedia content to be classified. “Descriptors” and “ingredients” are used for the classification. Descriptors make reference to the subject of a title, as well as to information relating to the creators of said title. For example, in the case of a movie, examples of descriptors could be “Science-Fiction” and “Horror”, as well as the names of director, actors/actresses, producer, etc. A single title may have more than one descriptor, each descriptor being, in turn, composed of several ingredients. The ingredients for a specific title are values ranging from 0 to 1, depending on how present said ingredient is in the specific title. 1 and 0 would stand for a 100% and 0% presence. For example, the descriptor “Science-Fiction” could have the ingredients “Space” (90%), “Aliens” (20%), “Time-travel” (20%), etc.

The term “history” or “user history”, used in case-based recommendation, refers to the list of titles consumed in the past by a specific user.

The term “profile” or “user profile” makes reference to the set of preferences explicitly or implicitly expressed by the user when using the content-based approach. Those preferences may comprise personal information regarding, for example, age, marital status, education, etc. Also, it may comprise information regarding how much the user liked previously seen titles, such information being, for example, numeric evaluations. Thus, a well-evaluated title is a title the user liked, and a badly-evaluated title is a title the user disliked. A “score” is the numeric evaluation assigned to a title by the user.

The term “component” makes reference to the modules or units used to generate the recommendations. Each “component” functions according to a different approach. Examples of possible approaches are, without limitation, case-based, content-based or Bayesian.

According to a first aspect of the present invention, a method for providing a recommendation of multimedia content to a user is described, the method comprising the steps of:
obtaining, at least, two lists of recommended titles, each list being obtained according to a different approach, based on a user database and a content database;
combining, in a combination module, the at least two lists of recommended titles obtained in the previous step based on confidence levels, in order to obtain a final list of recommended titles;
recommending the final list of recommended titles to the user.

According to preferred embodiments of the invention, the recommendation of multimedia content to the user is made periodically automatically or on request by the user.

Also, according to a preferred embodiment of the invention, the step of obtaining lists of recommended titles is carried out using, at least, two of the following approaches: content-based recommendation, case-based recommendation and Bayesian recommendation. Each of these recommendations is carried out separately in different components, as will be explained in detail later on in the present document.

### Content-Based Recommendation

Content-based recommendation uses information of the user profile, related to user preferences (encoded in the ingredients), in order to find titles matching said user preferences (“similarity” approach). Optionally, the user may be prompted to specify additional information, such as interest in a specific descriptor, for example, a specific actor, nationality or duration.

Since recommendations using solely the similarity approach show little variation, similarity is combined with “diversity” of the title with respect to the list of past recommended titles. Therefore, a title which is similar to the user preferences, and, at the same time, different from the titles recommended in the past is more likely to be recommended. More information on efficient combination of similarity and diversity is found in “Improving Recommendation Diversity”, of K. Bradley and B. Smyth, in D. O'Donoghue, editor, Proceedings of the Twelfth National Conference in Artificial Intelligence and Cognitive Science (AICS-01), pages 75-84, 2001, Maynooth, Ireland.

Therefore, content-based recommendation, according to a preferred embodiment, is based on a weighed combination of:
similarity between the user profile and a title;
diversity of said title with respect to the list of past recommended titles.

The weighed combination of similarity and diversity is encoded in the function “quality”. The function quality depends on the user profile, including the additional information provided, and on the information defining the titles not yet seen by the user. Thus, in order to obtain a list of recommended titles with a certain specified number of elements, a quality value is calculated for every title not yet seen by the user, and said titles are sorted according to their quality values. Then, the list of recommended titles is formed by choosing a specified number of the titles having the highest quality.

A further detailed description a preferred embodiment of content-based recommendation is provided later.

### Case-Based Recommendation

This approach is based on including, in the list of recommended titles, titles similar to those already seen and positively evaluated by the user. The functions “relevance” and “diversity” are used for generating said list of recommended titles.

Thus, case-based recommendation, according to a further preferred embodiment, is based on a weighed combination of

relevance of a title for the user;

diversity of said title with respect to the list of past recommended titles.

The first step in the case-based recommendation approach is calculating the “similarity table”. The similarity table is formed by comparing each title with the rest of titles in the content database. Then, for each title, the resulting list of similar titles is sorted according to similarity and a specified number of the most similar elements of the list is chosen. Thus, the result of this calculation is a table in which one dimension contains all the titles in the content database and the other dimension contains, for each of them, a list of the most similar titles. This calculation is made once, when the whole recommendation system is initiated. After that, titles are introduced in the similarity table upon arrival.

Then, for every title in the history of a user, the relevance value is calculated and a number of the most relevant titles are selected. The relevance value of a title is greater the better the title has been evaluated by the user and the more different it is from the previously recommended titles.

After that, the most similar titles to the chosen most relevant titles for the user are chosen from the similarity table. The recommendation list is made from that chosen list of titles, giving more weight to those having the descriptors most seen by the user.

### Bayesian Recommendation

According to another preferred embodiment, cooperative recommendation is based on Naïve Bayesian Classifiers. Naïve Bayesian Classifiers have the advantages of managing uncertainty, being able to work with incomplete information, providing ease of use due to their natural way to present information and calculating efficiently.

In order to generate the recommendation list, this approach calculates, for each ingredient, its probability to be preferred by the user. Then, the titles most matching the probabilities obtained for each ingredient are recommended. Content-based recommendation is used for assessing the similarity between the titles and the ingredients.

### Combination of Recommendation Lists

According to a further preferred embodiment of the invention, the step of combining the lists of recommended titles is based on a weighed combination of availability of information related to the user and success of the previously recommended titles by each approach. Such weighed combination is called “confidence”.

“Success” is calculated for each approach, that is, for each component, based on feedback information encoding how frequently a specific approach made a recommendation which was finally followed. That is, the more titles seen and positively evaluated by the user, out of those recommended by a specific approach, the more successful that approach is for said user.

“Availability”, on the other hand, is calculated differently for each approach, since each approach has different means of obtaining information on the user. Therefore:
Content-based: Availability depends on how detailed the user profile is, that is, how much additional information on preferences has been added by the user.
Case-based: Availability depends on the size of the history of the user.
Bayesian: Availability depends on the number of users in the system, the quantity of personal information provided by the user and the size of the history of the user.

Then, recommendations made by an approach having a high confidence for a user have more weight when combining the lists of recommended titles. The confidence of each approach is recorded in a confidence level database.

Finally, the list of recommended titles is recommended to the user.

According to a second aspect of the present invention, a method is described for providing a recommendation of a new title to users on arrival of said title, the method comprising:
deciding, according to at least two different approaches and based on a user database, whether to recommend or not the newly arrived title to each user;
combining the decisions made according to the at least two different approaches in the previous step in order to obtain a list of selected users;
recommending the newly arrived title to the selected users

According to a preferred embodiment of the present invention, the step of deciding whether to recommend or not a newly arrived title to each user is carried out according to the following approaches: content-based recommendation, case-based recommendation and Bayesian recommendation.

### Content-Based Recommendation

According to a preferred embodiment of the invention, content-based recommendation is based on similarity between the user profile and the newly arrived title. That is, the component carrying out the content-based recommendation approach calculates, for each user in the system, the similarity between the newly arrived title and the user. This calculation is made according to the previously provided definition of similarity.

### Case-Based Recommendation

According to another preferred embodiment of the present invention, case-based recommendation is based on searching relevant titles in the history of the user, for each user in the system, which are similar to the newly arrived title.

### Bayesian Recommendation

According to another preferred embodiment of the present invention, Bayesian recommendation is based on Naïve Bayesian Classifiers.

The component carries out the same probability calculation previously defined when creating a recommendation list automatically or on request by the user. Similarity is calculated, in this case, using the list of probabilities and the ingredients of the newly arrived title.

### Combination of Recommendation Lists

According to another preferred embodiment of the invention, the decisions made according to the different approaches are combined based on the confidence of the approaches and on the similarity provided by the approaches. The result is a list of decisions determining which users are recommended the newly arrived title.

The final step of the method is recommending the newly arrived title to the users of the list.

Another aspect of the present invention refers to a computer program comprising code adapted for performing the abovementioned method when executed on a data-processing system.

Finally, a further aspect of the invention describes a recommendation system for providing a recommendation of multimedia content to users which comprises:

at least two recommendation components for providing recommendation of multimedia content to users according to at least to different approaches;

a combination module for combining the recommendation of multimedia content to users based on confidence levels and for providing a final recommendation to said users;

a confidence level database for obtaining the confidence level of each recommendation of multimedia content to users based on the on the availability of information related to each user and on the success of the previously recommended titles by each recommendation module.

The expression “providing a recommendation of multimedia content to users” aims to include both a list of recommended titles for a user and a list of selected user to which recommending a newly arrived title.

### BRIEF DESCRIPTION OF THE DRAWINGS

FIG. 1 shows a diagram of the system of the present invention.

FIG. 2 shows a diagram of the system of the present invention when directed to recommendation made automatically or on request from the user.

FIG. 3 shows a block diagram of the confidence level calculation according to the present invention when directed to recommendation made automatically or on request from the user.

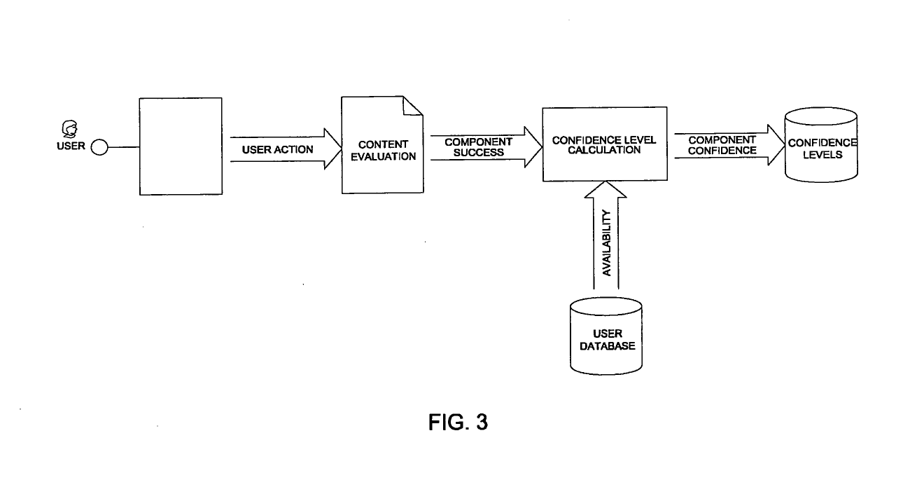

FIG. 4 shows a block diagram of the content-based recommendation approach when directed to recommendation made automatically or on request from the user.

FIG. 5 shows a block diagram of the case-based recommendation approach when directed to recommendation made automatically or on request from the user.

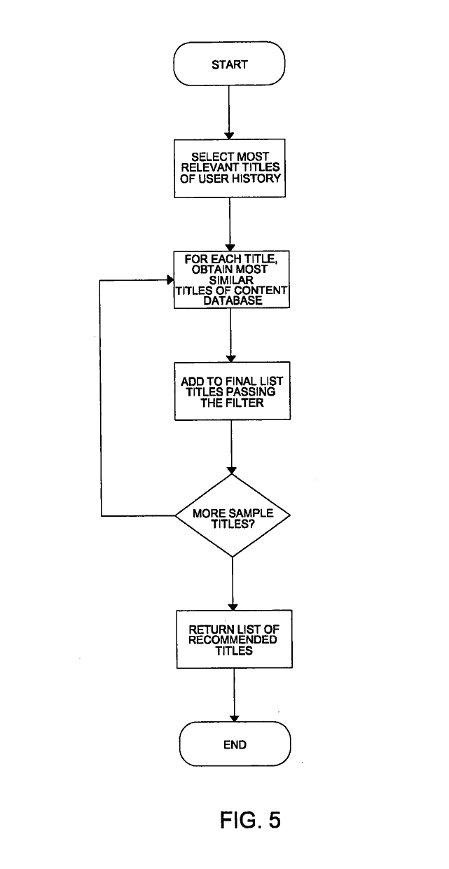

FIG. 6 shows a block diagram of the Bayesian recommendation approach when directed to recommendation made automatically or on request from the user.

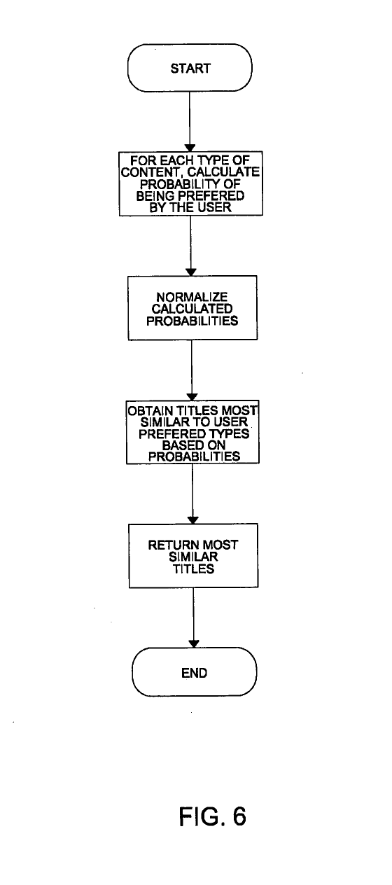

FIG. 7 shows a block diagram of the combination method when directed to recommendation made automatically or on request from the user.

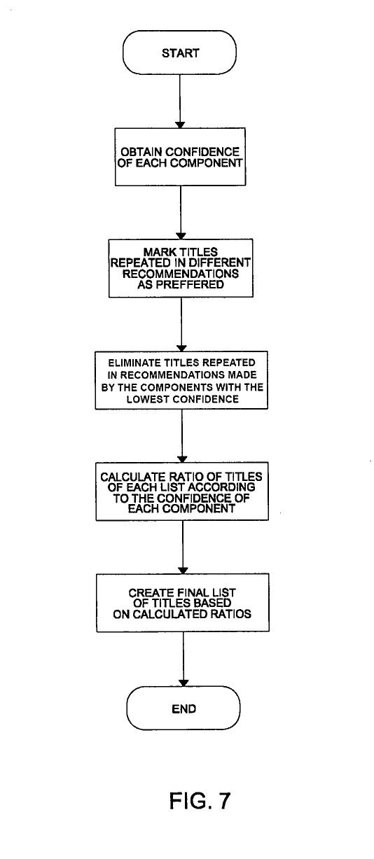

FIG. 8 shows a diagram of the system of the present invention when directed to recommendation on arrival of a new title.

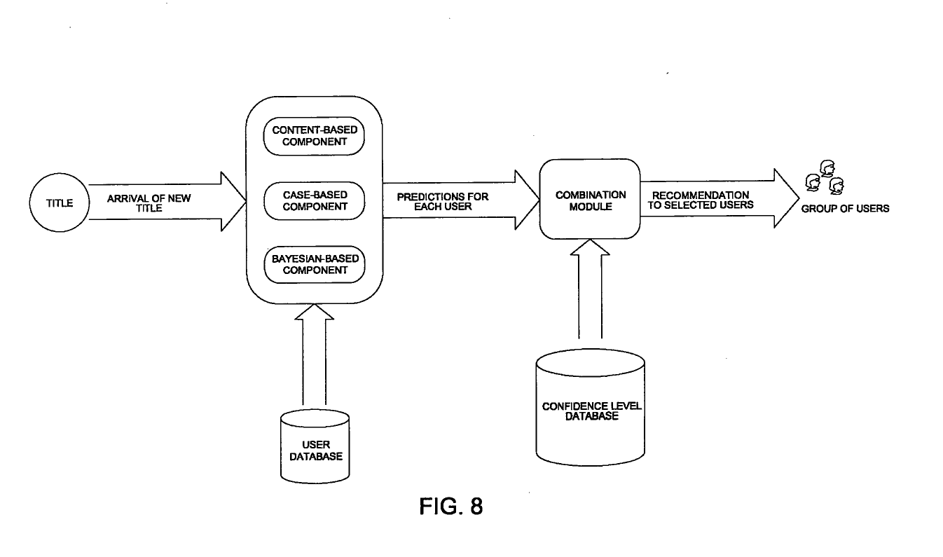

FIG. 9 shows a block diagram of content-based recommendation when directed to recommendation on arrival of a new title.

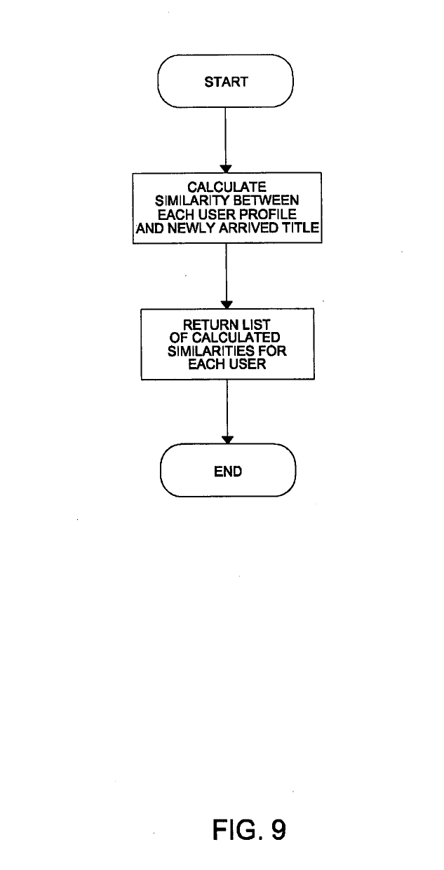

FIG. 10 shows a block diagram of case-based recommendation when directed to recommendation on arrival of a new title.

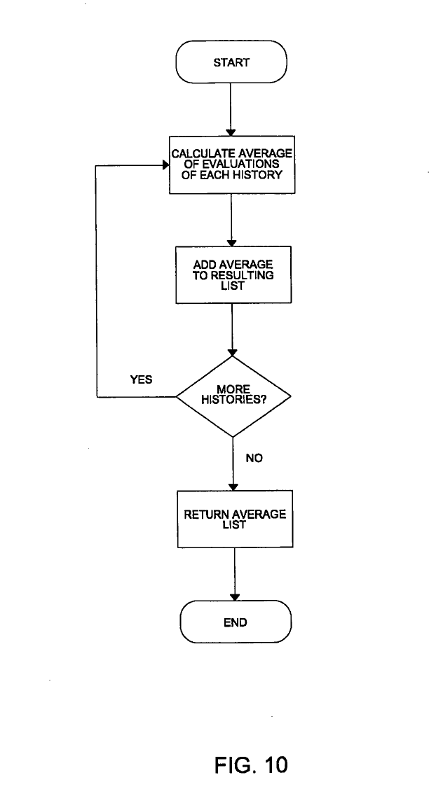

FIG. 11 shows a block diagram of Bayesian recommendation when directed to recommendation on arrival of a new title.

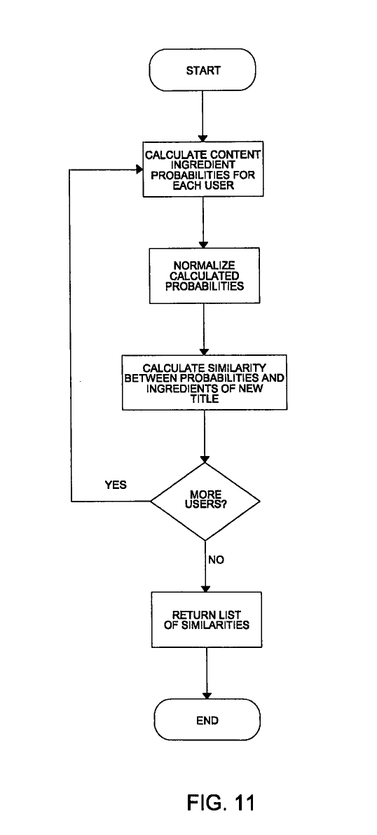

FIG. 12 shows a block diagram of the combination method when directed to recommendation on arrival of a new title.

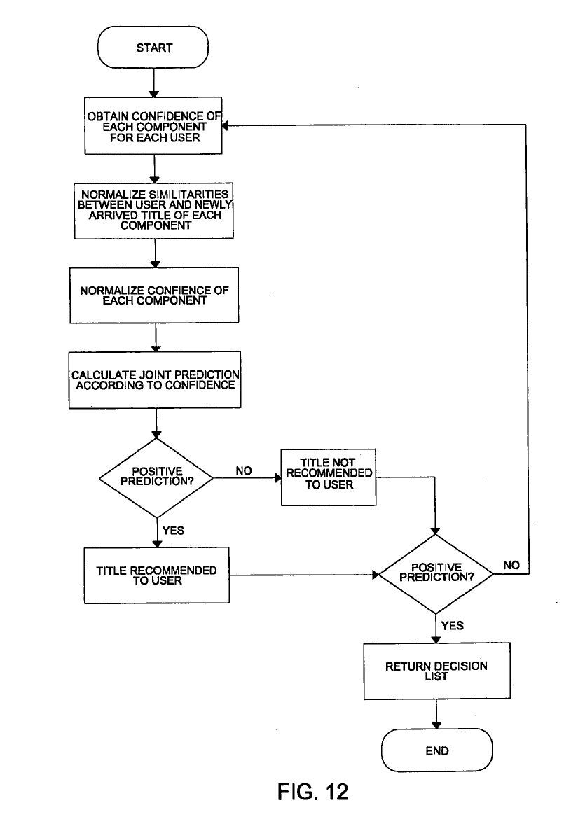

### DESCRIPTION OF PREFERRED EMBODIMENTS

A detailed description of a preferred embodiment of the present invention will be made, making references to the aforementioned figures. The following description is specifically directed to a movie recommendation system. In such case, descriptors would be, for example, “Science-Fiction”, “Drama”, “War”, “Horror” and the like, depending on the general subject of the movie. In turn, ingredients further specify the content of each descriptor by means of a numerical value encoding the presence of said ingredient in the movie. Possible ingredients of the descriptor “War” could be “Violence”, “Sea”, “Air”, “Land”, etc. In addition, other descriptors such as “Actor”, “Director”, “Producer”, “Duration”, etc. may be specified by the user.

For example, for the movie “Platoon”:
Descriptor 1: “War”

Ingredient 1: “Violence 80%”

Ingredient 2: “Land 100%”

Ingredient 3: “Friendship 70%”
Descriptor 2: “Willem Dafoe”
Descriptor 3: “Charlie Sheen”
Descriptor 4: “Oliver Stone”
Descriptor 5: “Duration>100 minutes”

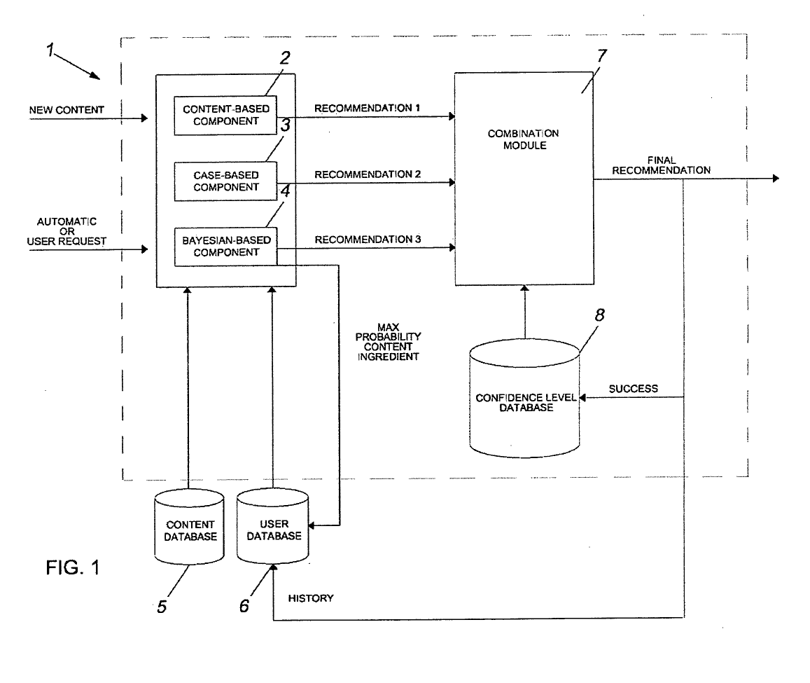

FIG. 1 represents a simplified diagram of one embodiment of the recommendation system (1) of the present invention. In this embodiment, three approaches are used for calculating a list of recommended movies, each being carried out in a different component: content-based recommendation component (2), case-based recommendation component (3) and Bayesian recommendation component (4). A movie database (5) and a user database (6) provide said components the information they require for making up the three different lists of recommended movies. A combination module (7) combines the three lists, based on confidence levels, and obtains a final list of recommended movies. The confidence levels are provided by a confidence level database (8).

### Example of Method for Providing Recommendation of Movies to a User, Either Automatically or on Request by the User

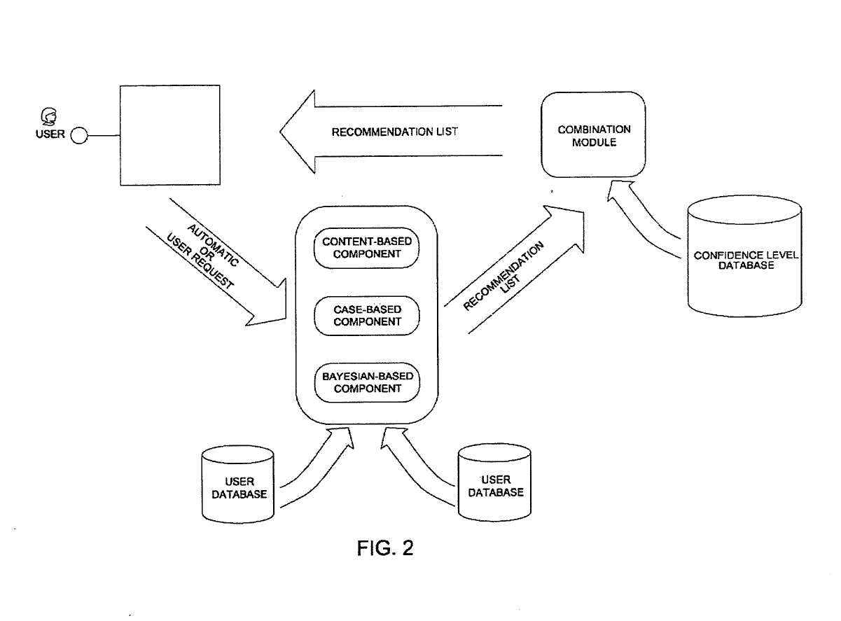

First of all, three lists of recommended movies are calculated according to three different approaches, namely content-based recommendation, case-based recommendation and Bayesian recommendation. Then, the three lists are combined in order to obtain a unique final list of recommended movies. This method is shown in FIG. 2.

### Content-Based Recommendation

As mentioned earlier in the present patent application, the list of recommended movies obtained according to the content-based recommendation approach is made using the so called “quality” function, which, in turn, is a weighed combination of “similarity” and “diversity”. The “quality” of a movie is high if the descriptors and ingredients defining said movie match those specified by the user in the user profile (“similarity”) and if the movie is different from the movies previously recommended to said user (“diversity”). The movies are sorted according to their “quality” value and those with the highest “quality” value are selected for making up the recommendation list. It is possible to specify the maximum number of movies in the recommendation list. Also, in order to improve the efficiency of the algorithm, a limit may be established as to the number of movies to compare with.

Further information on the use of “quality” is found in Smyth.

### Similarity

The numerical definition of “similarity” is:

Similarity(a,c)=ω*δ+(1− ω̅)*β

in which:
Similarity=value of the “similarity”, in the range [0, 1]. It is dependent on a (user profile descriptors and ingredients) and on c (movie descriptors and ingredients). The closest the “similarity” is to 1, the more interesting the movie is for the user;
ω=descriptor distributing similarity weight between the distance and the coincidences;
δ=Euclidian distance between user profile's ingredients and a title's ingredients;
ω̅=weight factor in the range [0, 1];
β=additional information regarding user preferences, such as a specific actor, director, movie duration, etc. In the present example, it is defined by the expression:

$$β = \frac{number\_of \_coincident \_descriptors}{λ} ,$$

wherein λ is a constant determining the weight assigned to each coincidence.
   In turn, the Euclidian distance is defined as follows:

$$δ = \sqrt{\frac{{\sum }_{i = 1}^{n} [ ( 1 - {( {a}_{i} - {c}_{i} )}^{2} ) * {a}_{i} ]}{{\sum }_{a = 1}^{n} {a}_{i}}}$$

wherein:
aᵢ=value of an ingredient of the user profile;
cᵢ=value of an ingredient of the movie

### Diversity

The numerical definition of “diversity” is:

$$\begin{matrix}Diversity ( c , R ) = 1 ; & if R = \{ \} ( R is empty ) \\ Diversity ( c , R ) = \frac{{\sum }_{i = 0}^{n} ( 1 - Similarity ( c , {r}_{i} ) )}{n} ; & otherwise\end{matrix}$$

wherein:
R=list of movies previously recommended to the user;

That is, if no movie has been previously recommended to the user, then the diversity of the movie in question is 1. Otherwise, the movie descriptors and ingredients are compared to those of the previously recommended movies.

### Quality

Finally, the “quality” function is defined as follows:

Quality(a,c,R)=(1−α)*Similarity(a,c)+α*Diversity(c,R)

wherein:
α=weight factor between Similarity and Diversity. A typical value of α is close to 0.5.

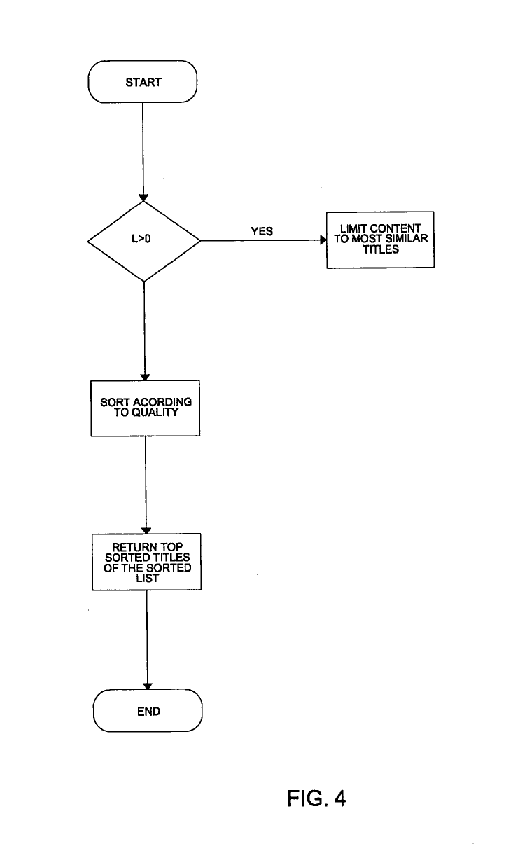

FIG. 4 discloses a simple algorithm for calculating a list of recommended movies using the content-based approach, in which L represents the maximum number of movies to compare with.

### Case-Based Recommendation

The recommendation list is made up of movies similar to those previously seen and positively evaluated by the user. The list is generated as follows:

First of all, upon initialization of the recommendation system (1), a “similarity table” is calculated. Each movie in the movie database (5) is compared with the rest of movies in said database (5), that is, their “similarity” value is calculated. Then, a specified number (k) of similar movies to a given one is chosen. The dimensions of the “similarity table” are therefore N×k, wherein:
N is the total number of movies in the movie database (5), and
k is the specified number of “similar” movies we want to store in the “similarity table”.

We have now all information regarding the “similarity” between a given movie and the rest of the movies in the database (5) encoded in the “similarity table”. The “similarity table” contains a list of the k most “similar” movies to each of the N movies in the database (5) of movies. On arrival of new movies to the movie database (5), the “similarity table” is updated.

Secondly, a specified number of movies (i) is chosen from the history of the user, on the condition that those movies are positively evaluated by the user and that they are “diverse”. A new parameter called “Quality2” is used for selecting said movies

Quality2(c,R)=(1−α)·Relevance(c)+α·Diversity(c, R)

wherein:
Relevance=a measure of the relevance of a movie “c” for a specific user. It is calculated based on the evaluation of the movie by the user minus a predetermined value depending on how old the movie is. Therefore, the older a movie is, the less relevant it becomes.
Similarity=defined previously

Then, movies are searched in the similarity table which are “similar” to the i chosen movies with the highest “Quality2” value. Finally, the recommendation list is generated giving a higher weight to those movies having descriptors and ingredients matching the profile of the user.

### Bayesian Recommendation

A Bayesian classifier is used to build the recommendation lists. Specifically, Naïve Bayesian Classifiers are used, which consist of a two level tree, wherein the root node represents the subject of the recommended movie and the sub-nodes are divided as follows:

one node for each descriptor of personal data (hobbies, marital status, age . . . )

two nodes for the type (that is, the descriptor type) of movies the user has most frequently seen in the past (more relevant according to his history).

Mathematically, according to the Bayes rule:

P(Y=yₖ|X₁ . . . Xₙ)=P(Y=yₖ)*P(X₁ . . . Xₙ|Y=yₖ)

wherein
Y is the random discrete variable representing the class of ingredients of the movie,
yₖ represents a specific movie ingredient, and
X₁ . . . Xₙ are discrete variables constituting the child nodes of the tree.

Assuming the variables X₁ . . . Xₙ are conditionally independent, and using the aforementioned classifier, the equation is simplified:

$$P ( Y = {y}_{k} \vert {X}_{1} … {X}_{n} ) = P ( Y = {y}_{k} ) {\prod }_{i} P ( {x}_{i} \vert {y}_{k} )$$

wherein P(Y=Yₖ) is calculated based on the frequency of the presence of yₖ in the content database (5) used.

On the other hand, the value of P(Xᵢ|yₖ) is calculated using an estimator which solves the problem of the absence of information, thereby avoiding probabilities with a zero value.

$$P ( {x}_{i} \vert {y}_{k} ) = \frac{{n}^{′} + m L}{n + m}$$

wherein
n is the number of users in the database (5) with Y=yₖ,
n′ is the number of users with Y=yₖ and Xᵢ=xᵢ,
m is the number of child nodes considered in the classification, and
L is the inverse of the number of different values of Xᵢ

The system may use two different types of information.

On one hand, static information will not change substantially with time. It basically comprises personal information explicitly provided by the user.

On the other hand, dynamic information is periodically updated by the system. It comprises information on the types of movies that are most relevant according to the history of the user, which is re-calculated each time the user sees a new movie. It also comprises the movie ingredient with the highest possibility of being the most preferred ingredient for the user.

Further information on this type of classifier is found in T. Mitchell.

### Combination Module

The three lists of recommended movies of the previous steps are now combined based on the confidence level assigned to each of the approaches. The confidence level of an approach, which is different for every user, is calculated based on feedback information and on the quantity of information available. In the case of feedback information, the confidence level of a certain approach will be high if the movies previously recommended by that approach have been positively evaluated by the user. On the other hand, the quantity of information available is calculated differently depending on the approach:
Content-based: The quantity of information depends on the quantity of optional information provided by the user.
Case-based: The quantity of information depends on the size of the history of the user.
Bayesian: The quantity of information depends on the number of users in the system, on the quantity of personal information provided by the user and on the size of the history of the user.
   The result of the combination, which is carried out in the combination module (7), is the final list of recommended movies for a specific user.

Therefore, a confidence level parameter is defined:

Confidence(s,u)=α*Success(s,u)+(1−α)*Availability(s,u)

wherein:
Success(s,u) Function evaluating the “success” of a movie (s) with respect of a user (u), depending on the ratio between the total score provided by the user and the number of recommendations of the movie (s).
Availability(s,u) Function dependent on the approach:

### Content-Based:

Availability(s,u)=β*(no. of optional descriptors provided by the user)+α

wherein α is a minimum value

### Case-Based:

Function depending on the number of movies seen by the user:

Availability(s,u)=0,1 for movie≧5

Availability(s,u)=1,0 for movie≧50

### Bayesian:

A scale is created based on the number of users of the system. Then:

Availability(s,u)=δ*(value_depending_number_of_users)

Availability(s,u)=γ*(number_of_personal_descriptors_of_user)

Availability(s,u)=+(1−(δ+γ))*(value_depending_number_movies_seen_by_user)

In the present example, it has been decided that the confidence level parameter must be within the range [0, 1]. Therefore, functions “success” and “availability” are defined accordingly.

### Example of Method of Providing a Recommandation of a Movie to Users on Arrival of said New Movie.

When a new movie is introduced into the content database, the system calculates the “similarity” values according to each approach. Then, the combination module decides which users must be recommended the movie depending on the confidence level of each approach. The result of this method is a list of decisions determining which users are recommended the newly arrived movie.

### Content-Based Recommendation

The content-based component calculates the “similarity” between the newly arrived movie and each user profile using function SIM(u, c) defined in the previous example.

### Case-Based Recommendation

The case-based component looks for relevant movies in each user history which are “similar” to the newly arrived movie. Thus, movies in the user history which have a “relevance” value above a certain threshold are compared with the new movie, and if the “similarity” value between said movies and the new movie is above another specified value, the new movie is recommended to that user.

### Bayesian Recommendation

The Bayesian component performs, for each user, the same probability calculation disclosed in the previous example for the Bayesian recommendation component.

### Combination Module

Now, the combination module decides, based on the confidence of each component, whether the new movie is recommended to the users. In order to do that, and always for each of the users:
The combination module calculates the confidence values for each component, using the similarity values provided by said components.
The combination module compares the confidence values with certain predetermined thresholds. If the condition is fulfilled, then a positive recommendation is generated for that component.
If one recommendation is positive, then the movie is recommended to the user.
Finally, the confidence level database records which components made the right guess regarding the recommendation. Consequently, the confidence level of the components is modified according to their performance.

Although the present invention has been described in detail for purpose of illustration, it is understood that such detail is solely for that purpose, and variations can be made therein by those skilled in the art without departing from the scope of the invention.

Thus, while the preferred embodiments of the methods and of the system have been described in reference to the environment in which they were developed, they are merely illustrative of the principles of the invention. Other embodiments and configurations may be devised without departing from the scope of the appended claims.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. Recommendation method for multimedia content, the method comprising the steps of:
obtaining, at least, two lists of recommended titles, each list being obtained according to a different approach, based on a user database (6) and a content database (5);
combining the, at least, two lists of recommended titles obtained in the previous step based on confidence levels, in order to obtain a final list of recommended titles;
recommending the final list of recommended titles to a user.

2. Method according to claim 1, wherein the recommendation of multimedia content to a user is made on request by the user.

3. Method according to claim 1, wherein the recommendation of multimedia content to a user is made periodically automatically.

4. Method according to claim 1, wherein the step of obtaining lists of recommended titles is carried out based on, at least, two of the following approaches: content-based recommendation, case-based recommendation and Bayesian recommendation.

5. Method according to claim 4, wherein the content-based recommendation is based on a weighed combination of similarity between the user profile and a title and diversity of said title with respect to the list of past recommended titles.

6. Method according to claim 4, wherein the case-based recommendation is based on a weighed combination of relevance of a title for the user and diversity of said title with respect to the list of past recommended titles.

7. Method according to claim 4, wherein the cooperative recommendation is based on Naïve Bayesian Classifiers.

8. Method according to claim 4, wherein the step of combining the lists of recommended titles is based on the confidence of the components and on the similarity provided by the components.

9. Recommendation method for multimedia content on arrival of a new title, the method comprising:
deciding, according to, at least, two different approaches and based on a user database (6), whether to recommend or not the newly arrived title to each user;
combining the decisions made according to the at least two different approaches in the previous step in order to obtain a list of selected users;
recommending the newly arrived title to the selected users.

10. Method according to claim 9, wherein the step of deciding whether to recommend or not a newly arrived title to each user is carried out based on, at least, two of the following approaches: content-based recommendation, case-based recommendation and Bayesian recommendation.

11. Method according to claim 10, wherein the content-based recommendation is based on similarity between the user profile and the newly arrived title.

12. Method according to claim 10, wherein the case-based recommendation is based on searching relevant titles in the history of the user which are similar to the newly arrived title.

13. Method according to claim 10, wherein the Bayesian recommendation is based on Naïve Bayesian Classifiers.

14. Method according to claim 10, wherein the step of combining decisions made according to the different approaches is based on the availability of information related to the user and on the success of the previously recommended titles by each approach.

15. Computer program comprising program instructions for causing a computer to perform the method according to claim 1.

16. Computer program according to claim 15, embodied on storing means.

17. Computer program according to claim 15, carried on a carrier signal.

18. Recommendation system (1) for multimedia content, comprising:
at least two recommendation components (2, 3, 4) for providing recommendation of content to users according to at least two different approaches;
a combination module (7) for combining the recommendation of multimedia content to users based on confidence levels and for providing a final recommendation to said users;
a confidence level database (8) for obtaining the confidence level of each recommendation of multimedia content to users based on the availability of information related to each user and on the success of the previously recommended titles by each recommendation component (2, 3, 4).
